(19) United States
(12) Patent Application Publication
(10) Pub. No.: US 2025/0283833 A1
(43) Pub. Date: Sep. 11, 2025

(54) METHOD AND DEVICE FOR INSPECTING CYLINDRICAL CONTAINERS

(71) Applicant: Syntegon Technology GmbH, Waiblingen (DE)

(72) Inventors: José Gaspar Mueller, Bedburg (DE); Johannes Roggemann, Stuttgart (DE)

(21) Appl. No.: 18/862,603

(22) PCT Filed: Apr. 4, 2023
(86) PCT No.: PCT/EP2023/058730

§ 371 Date: Nov. 4, 2024

(30) Foreign Application Priority Data
May 19, 2022 (DE) 10 2022 112 639.0

(51) Int. Cl. G01N 21/90; G01N 21/84

(52) U.S. Cl. CPC G01N 21/90; G01N 2021/845

(57) ABSTRACT

The invention relates to a method for inspecting cylindrical containers (10), comprising the steps of: providing an area scan camera (12) having a coverage (14); providing the containers (10); transporting the containers (10) in a transport direction (16) through the coverage (14) of the area scan camera (12); rotating the containers (10) and/or a liquid (18) accommodated in the containers (10) about a longitudinal axis (20) of the relevant container (10) in a direction of rotation (22) while the containers (10) are located in the coverage (14) of the area scan camera (12); capturing at least one sequence of pixel rows (26) by means of the area scan camera (12), wherein the pixel rows (26) are aligned with a specified area of a container (10) or with a specified area of a container (10) from various rotational positions of the container (10). The invention also relates to a device (32) for inspecting cylindrical containers (10).

### BACKGROUND

The invention relates to a method for inspecting cylindrical containers, and a device for inspecting cylindrical containers.

When inspecting cylindrical containers, a line scan method can be used. In this case, a line scan camera is used. The line scan camera can capture pixel rows aligned with an object. A pixel row can be represented by individual pixels arranged next to each other along a straight line. A pixel row can be described as a (pixel) vector. The pixel row can be considered as one-dimensional. Using the pixel row, a dimension of an object can be captured or displayed. The containers to be inspected are moved in a transport direction and rotated in the process. The containers are passed in front of the line scan camera, so that the line scan camera can capture one of the containers.

The line scan camera is moved from an initial position in the transport direction along with the container, which is detected by the line scan camera. The line scan camera takes a number of pixel rows of the container one after the other. The row images are then combined to form a (two-dimensional) row image. In the case of a cylindrical container, such a row image corresponds, for example, to the developed lateral surface of the cylindrical container.

Possible damage to the containers and/or foreign bodies within the containers can be better displayed or identified in such a row image. A reasons for this is, inter alia, that optical distortions (e.g., due to a rounded shape of the containers to be inspected) in a (one-dimensional) pixel row are only minimal compared to a conventional (two-dimensional) surface image.

As soon as the line scan camera has captured enough images (or pixel rows), the line scan camera is moved back to its starting position, where it can capture the next container. The line scan camera must then be moved along with the next container in the transport direction and then moved back again to its starting position. This process is repeated for each container to be inspected.

The line scan camera must therefore be moved back and forth along the transport direction. Various movement mechanisms can be used for this purpose.

Alternatively, movable mirror optics can be used to track the movement of the transported container. Here as well, different movement mechanisms can be used.

A disadvantage in this case is that only one container can be inspected at a time using the line scan camera. Furthermore, it requires a movement mechanism, which can be a source of disturbances, errors, inaccuracies, etc.

### SUMMARY

It is therefore an object of the present invention to provide a method and a device for inspecting cylindrical containers, wherein the above disadvantages are eliminated.

The above object is achieved by a method for inspecting cylindrical containers according to the disclosure. The containers can be rotationally symmetrical containers, such as bottles, vials, ampoules or syringes. The containers can be designed to be transparent, in particular to the human eye.

The method comprises the steps of:

Providing an area scan camera having a coverage. The area scan camera is in particular a camera having a two-dimensionally arranged recording medium. The area scan camera can have a sensor (e.g., a CCD sensor) that has a matrix of pixels (image pixels), which allows for two-dimensional (area) image capture with only one exposure cycle. The coverage is in particular two-dimensional. The coverage can be designed as an (in particular rectangular) detection plane.

Providing the containers (to be inspected).

Transporting the containers in a transport direction through the coverage of the area scan camera. The transport direction can correspond to a straight line and/or at least partially to a circular or elliptical path. The containers can be transported continuously or in a stepwise manner.

Rotating the containers and/or a liquid accommodated in the containers about a longitudinal axis of the respective container in a direction of rotation, while the containers are located in the coverage of the area scan camera.

Capturing (reading out) at least one sequence of pixel rows using the area scan camera. The pixel rows are aligned with a specified area of a container. In this case, in particular the liquid in the container is rotated while the container itself is not rotated. The containers can be set in rotation before the coverage. Before the containers are moved into the coverage, their rotational movement can be stopped, so that they no longer rotate. In this case, however, the liquid continues rotate within the containers. This allows the containers to be transported through the coverage, wherein the containers are not rotated in the coverage, but the liquid inside the containers is rotated.

Alternatively, the pixel rows are aligned with a specified area of a container from different rotational positions of the container. In this case, in particular the containers (including liquid) are rotated as they are moved through the coverage.

In particular, each of the captured pixel rows corresponds to a one-dimensional image.

A pixel row can be formed by individual pixels arranged next to each other along a straight line (pixel row). It is also conceivable that a pixel row can be formed from two or more adjacent pixels arranged next to each other along a straight line (two or more adjacent pixel rows).

As the container is moved through the coverage of the area scan camera, a sequence of pixel rows can be created (captured) of each container. In this case, the pixel rows can be captured in temporal succession. Thus, for example, a first pixel row can be captured at a first point in time and a second pixel row adjacent to the first pixel row can be captured at a second point in time after the first point in time.

In other words, a first pixel row can be captured at a first point in time. A second pixel row can be captured at a second point in time. A third pixel row can be captured at a third point in time, and so on. In this case, the first, second and third pixel rows can each represent (temporally) successive pixel rows. In other words, the pixel rows can be captured in temporal succession. The first, second and third pixel rows can each be (spatially) adjacent pixel rows or can be represented by (spatially) adjacent pixels.

The pixel rows are captured in temporal and spatial succession.

The container can thus be tracked while it is transported through the coverage of the area scan camera. The area scan camera does not have to be moved with the container for this.

According to a development, at least two sequences of pixel rows can be captured (read out) at least partially simultaneously by means of the area scan camera. The pixel rows of each sequence can be aligned with a specified area of a different container. The pixel rows of each sequence can be aligned with a specified area of a different container from different rotational positions of the respective container.

This allows multiple containers to be tracked while they are transported through the coverage. This means that a plurality of containers can be inspected at once (simultaneously) using the same area scan camera.

According to a development, the specified area of a container with which the pixel rows of a sequence are aligned can be a longitudinal axis of the container. In other words, the pixel rows of a sequence can be aligned with the longitudinal axis of a container. In other words, a pixel row can always extend along the longitudinal axis, in particular the longitudinal center axis, of a container. If a plurality of sequences of pixel rows is captured, the pixel rows of the individual sequences of pixel rows can be aligned with the longitudinal axes of the respective containers.

According to a development, at least one row image can be created from a captured sequence of pixel rows. In other words, a plurality of pixel rows, in particular which are temporally and preferably spatially successive, can be combined to form a row image. Each row image can be considered as being composed of a plurality of pixel rows arranged next to one another, in particular temporally and preferably spatially successive pixel rows.

The row image can be analyzed in order to determine the inspection result. The row image can show whether, for example, there are contaminants in the container or in the liquid accommodated in the container. The row image is in particular designed as a two-dimensional image. From such a row image, for example contamination in the container can be identified particularly well.

According to a development, the method can comprise the step of:

Aligning the area scan camera, the coverage and/or the transported containers in such a way that the containers remain in the coverage of the area scan camera for as long as possible during transport through the coverage. This can be achieved, for example, by orienting the coverage as parallel as possible to the transport direction. The transport direction can be oriented parallel to the coverage. In particular, the transport direction can extend within the coverage designed as the detection plane.

This allows for maximum use to be made of the coverage. Thus, for example, depending on the exposure time of the area scan camera and the rotation speed of the containers (or of the liquid accommodated in the containers), as many pixel rows and row images composed of them as possible can be created for each container. This can lead to an improved inspection result.

In addition, the mechanical backward movement of a swivel arm or mirror optics, which would otherwise have a time-consuming effect, is eliminated. This means that the inspection time increases in proportion to the reduction in backward movement.

According to a development, the method can comprise the step of:

Providing an optical lens system (and/or at least one lens), in particular at least one telecentric, one bi-telecentric and/or one endocentric lens, in order to avoid image distortions when capturing the sequence of pixel rows by means of the area scan camera. In this way, distortions can be avoided or at least reduced, leading to a more accurate inspection result.

According to a development, the method can comprise the step of:

Generating a trigger signal dependent on the movement of the containers, wherein the trigger signal is used to synchronize a sequence of pixel rows with at least one moving container. In this way, the movement of the containers can be synchronized with the generation of pixel rows and thus the movement of the container can be compensated. The trigger signal may depend on the position of the containers.

The temporal course of the inspection can be controlled by at least one parameter, in order to compensate for the movement of the containers. Such a parameter can be, for example, a start/stop or pixel row capturing signal, a shift by a certain number of pixel rows, a container number selection or input, a first pixel row for capturing and/or a synchronous/asynchronous mode.

According to a development, the capturing of at least one pixel row can be carried out by fading in the pixels (pixel row or pixel rows) of the area scan camera that contribute to the pixel row and fading out the pixels (pixel row or pixel rows) of the area scan camera that do not contribute to the pixel row. The fading in or out of the respective pixels (pixel row or pixel rows) can be implemented, for example, by activating or deactivating the individual sensors on an image sensor or its pixel matrix. An image sensor can be designed in the form of a chip, e.g. as a CCD chip, CMOS chip, etc.

According to a development, the fading in and/or fading out of the pixels of the area scan camera for generating at least one pixel row can be synchronized with the movement of a container, in particular with its position, by means of the trigger signal. This makes it easy to create a sequence of pixel rows that is synchronized with the movement of the container.

The above object is further achieved by a device for inspecting cylindrical containers according to the disclosure. The containers can be rotationally symmetrical containers, such as bottles, vials, ampoules or syringes. The containers can be transparent, in particular to the human eye.

The device comprises a transport device for transporting the containers in a transport direction. The transport device can be designed to transport (move) the containers continuously or in a stepwise manner.

The device further comprises at least one rotation device for rotating the containers and/or a liquid accommodated in the containers about a longitudinal axis of the respective container in a direction of rotation.

The device also comprises an area scan camera having a coverage. The area scan camera and/or the transport device are designed and arranged such that the containers pass through the coverage of the area scan camera.

The device is designed to capture at least one sequence of pixel rows by means of the area scan camera. The pixel rows are aligned with a specified area of a container or a specified area of a container from different rotational positions of the container. The device is further aligned to assemble the captured sequence of pixel rows into a row image.

The pixel rows are captured in temporal and spatial succession.

The containers can thus be tracked while they are transported through the coverage. The area scan camera does not have to be moved with the containers for this purpose.

According to a development, the area scan camera can be arranged immovably in the device. In other words, the area scan camera can be fixed and therefore cannot be moved. In particular, the area scan camera is not moved with the containers in the transport direction. In this way, movement mechanisms for the area scan camera can be dispensed with.

According to a development, the device can comprise a lens system. The area scan camera can have a lens. The device or the area scan camera can comprise at least one lens. The lens can be a telecentric, a bi-telecentric or an endocentric lens. In this way, image distortions can be avoided or at least reduced when capturing a sequence of pixel rows using the area scan camera.

According to a development, the device can be designed to carry out a method according to the above statements. With regard to the advantages that can be achieved thereby, reference is made to the statements relating to the method. For the further design of the device, the measures described in connection with the method and/or the measures explained below can be used.

### BRIEF DESCRIPTION OF THE DRAWINGS

Further features, details and advantages of the invention emerge from the wording of the claims and from the following description of embodiments with reference to the drawings, in which, in each case schematically:

FIG. 1 shows a device for inspecting containers;

FIG. 2 shows a pixel row captured by an area scan camera;

FIG. 3 is an illustration of a method for inspecting containers using the device from FIG. 1, and

FIG. 4 is an illustration of a further embodiment of the method for inspecting containers using the device from FIG. 1.

### DETAILED DESCRIPTION

In the following description and in the figures, corresponding components and elements bear the same reference signs. For improved clarity, not all reference signs are reproduced in all figures.

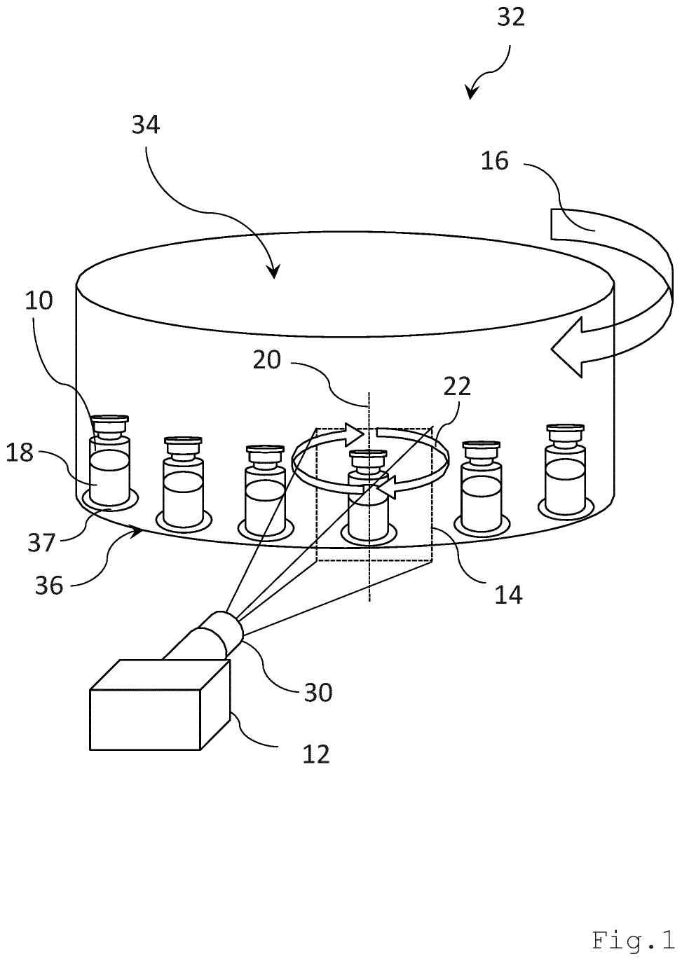

FIG. 1 schematically shows a device 32 for inspecting containers 10. The containers 10 are, in the present case, vials filled with a liquid 18.

The device 32 has a transport device 34, which, in the present case, is designed in the form of a conveyor wheel or a transport carousel. The transport device 34 transports the containers 10 in a transport direction 16. In the present case, the containers 10 are moved on a circular path by means of the transport device 34.

The device 32 furthermore comprises a rotation device 36. This is designed to rotate each of the transported containers 10 about a longitudinal axis 20 in a direction of rotation 22. In the present case, the rotation device 36 is designed in the form of individual, rotating receptacles 37. In this case, each of the transported containers 10 is arranged in a separate receptacle 37 of the rotation device 36. In other words, each container 10 received in a receptacle 37 is rotated in each case about the respective longitudinal axis 20 by means of the receptacle 37.

The device 32 further comprises an area scan camera 12 having a coverage 14. In the present case, the area scan camera 12 is arranged immovably (fixed). In other words, the area scan camera 12 is not moved, in particular with respect to the transport device 34. In the present case, the area scan camera 12 has a bi-telecentric lens 30.

The area scan camera 12, the coverage 14 and the transport device 34 are designed and arranged relative to one another such that the containers 10 are transported through the coverage 14 of the area scan camera 12 by means of the transport device 34.

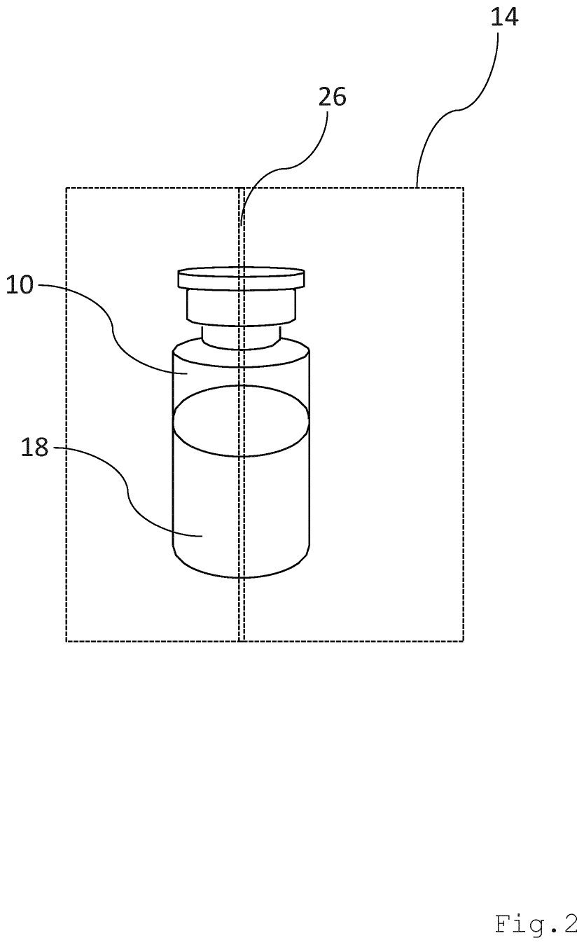

FIG. 2 shows a pixel row 26 captured by means of the area scan camera 12. In the illustrated coverage 14 of the area scan camera 12, a container 10 having a liquid 18 accommodated therein is completely imaged. The pixel row 26 corresponds, in the present case, to a pixel row (vertical in FIG. 2) of the coverage 14. A pixel row refers to pixels (image points) of a vertically oriented row of the coverage 14 in FIG. 2. Depending on the position of the coverage 14 at which the container 10 is arranged, the desired pixel row 26 or the desired pixel row oriented vertically in FIG. 2 of the coverage 14 of the area scan camera 12 can be selected.

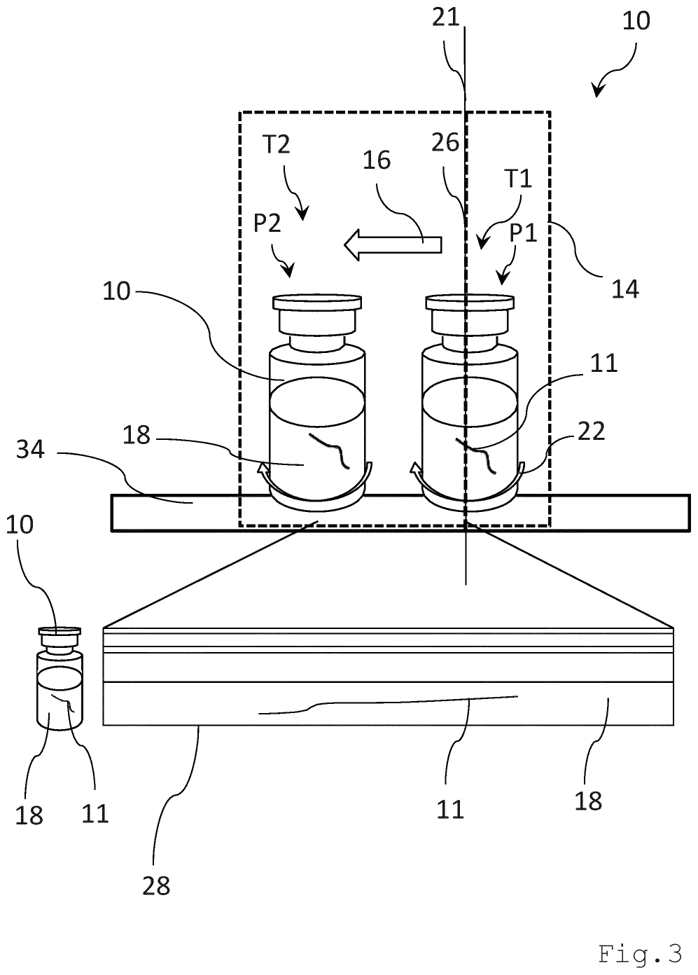

FIG. 3 illustrates a method for inspecting containers 10 using the device 32 from FIG. 1.

In FIG. 3, the coverage 14 of the area scan camera 12 is indicated by a dashed rectangle. In the present case, the coverage 14 is in the form of a rectangular plane.

In the coverage 14 of the area scan camera 12, a container 10 is imaged at a first position P1 at a point in time T1. The container 10 is transported in the transport direction 16 (to the left in FIG. 3) through the coverage 14 of the area scan camera 12. The same container 10 is shown at a later point in time T2 at a second position P2. During transport through the coverage 14, the container 10 is rotated about its longitudinal center axis 21 in the direction of rotation 22.

A liquid 18 is accommodated within the container 10. Within the liquid 18 (and thus within the container 10), there is an (undesirable) contamination in the form of a foreign body 11.

At the point in time T1, the area scan camera 12 captures a pixel row 26 from the container 10 at the first position P1. The pixel row 26 extends along the longitudinal center axis 21 of the container 10 at the point in time T1. The container 10 is transported or moved further in the transport direction 16 by means of the transport device 34 (shown only schematically).

At the point in time T2, the container 10 has reached the position P2 and has, in the present case, rotated completely (by 360°) about the longitudinal center axis 21.

Between the point in time T1 and the point in time T2, a plurality of pixel rows 26 is captured by means of the area scan camera 12. Since the container 10 is moved from right to left (in the transport direction 16) in the coverage 14 of the area scan camera 12 in FIG. 3, the corresponding pixel row 26 extending through the longitudinal center axis 21 of the container 10 also migrates in the transport direction 16. The pixel row 26 therefore also migrates within the coverage 14, in each case in a manner analogous to the container 10.

The pixel rows 26 captured in this way can be reassembled in the temporally successive order to form a row image 28. Such a row image 28 is shown schematically at the bottom of FIG. 3. The row image 28 corresponds to the developed lateral surface of the container 10 (cf. the container 10 shown in FIG. 3 to the left of the row image 28).

The foreign body 11 is particularly clearly visible from the row image 28. The container 10 shown can therefore be identified as not in order due to the foreign body 11.

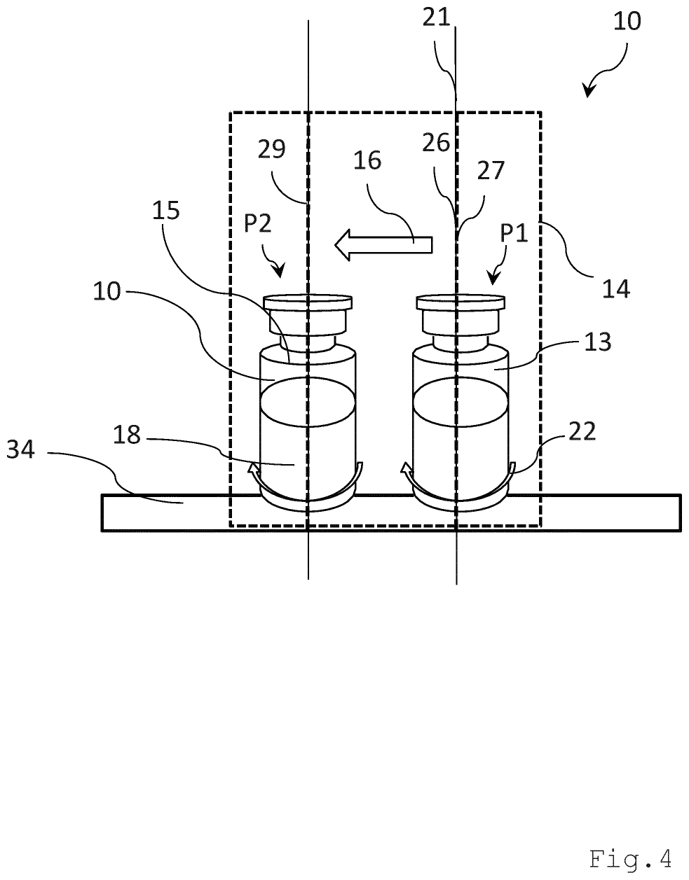

FIG. 4 illustrates the method for inspecting containers 10 by means of the device 32 from FIG. 1 according to a further embodiment.

The embodiment shown differs from the embodiment shown in FIG. 3 in that two containers 10 are shown at the same time in the coverage 14 of the area scan camera 12. A first container 13 is shown at position P1 and a second container 15 is shown at position P2.

In the present case, two pixel rows 26 are now captured at the same time. In this case, a first pixel row 27 extends along the longitudinal center axis 21 of the first container 13, and a second pixel row 29 extends along the longitudinal center axis 21 of the second container 15.

Analogously to the embodiment of FIG. 3, the two pixel rows 27, 29 migrate in the transport direction 16, together with the two containers 13, 15. Subsequently, a first row image can be created from the first pixel rows 27, and a second row image from the second pixel rows 29. Thus, two line images 28 (not shown) can be created from the first and the second pixel rows 27, 29. In this case, the first line image corresponds to the developed lateral surface of the first container 13. In this case, the second line image corresponds to the developed lateral surface of the second container 15.

In this way, two (or more) containers 10 can be inspected simultaneously using the same area scan camera 12.

1. A method for inspecting cylindrical containers (10), comprising:
providing an area scan camera (12) having a coverage (14),
providing the containers (10);
transporting the containers (10) in a transport direction (16) through the coverage (14) of the area scan camera (12),
rotating the containers (10) and/or a liquid (18) accommodated in the containers (10) about a longitudinal axis (20) of the respective container (10) in a direction of rotation (22) while the containers (10) are located in the coverage (14) of the area scan camera (12),
capturing at least one sequence of pixel rows (26) by the area scan camera (12), wherein the pixel rows (26) are aligned with a specified area of a container (10) or with a specified area of a container (10) from various rotational positions of the container (10), wherein the pixel rows are captured in temporal and spatial succession.

2. The method according to claim 1, wherein at least two sequences of pixel rows (26) are captured at least partially simultaneously by the area scan camera (12), wherein the pixel rows (26) of each sequence are aligned with a specified area of another container (10) or with a specified area of another container (10) from different rotational positions of the respective container (10).

3. The method according to claim 1, wherein the specified area of a container (10) to which the pixel rows (26) of a sequence are aligned is a longitudinal axis (20) of the container (10).

4. The method according to claim 1, wherein at least one row image (28) is created from a captured sequence of pixel rows (26).

5. The method according to claim 1, wherein the method further comprises:
aligning the area scan camera (12), the coverage (14) and/or the transported containers (10) such that the containers (10) remain in the coverage (14) of the area scan camera (12) for a maximum time during transport through the coverage (14).

6. The method according to claim 1, wherein the method further comprises:
providing an optical lens system to avoid image distortions when capturing the sequence of pixel rows (26) by the area scan camera (12).

7. The method according to claim 1, wherein the method further comprises :
generating a trigger signal dependent on movement of the containers (10), wherein the trigger signal is used to synchronize a sequence of pixel rows (26) with a moving container (10).

8. The method according to claim 1, wherein the capturing of at least one pixel row (26) is carried out by fading in the pixels of the area scan camera (12) that contribute to the pixel row (26) and fading out the pixels of the area scan camera (12) that do not contribute to the pixel row (26).

9. The method according to claim 8, wherein the fading in and/or fading out of the pixels of the area scan camera (12) for generating at least one pixel row (26) is synchronized by a trigger signal with movement of the corresponding container (10).

10. A device (32) for inspecting cylindrical containers (10), comprising
a transport device (34) for transporting the containers (10) in a transport direction (16),
at least one rotation device (36) for rotating the containers (10) and/or a liquid (18) accommodated in the containers (10) about a longitudinal axis (20) of the respective container (10) in a direction of rotation (22),
an area scan camera (12) having a coverage (14), wherein the area scan camera (12) and/or the transport device (34) are configured and arranged such that the containers pass through the coverage (14) of the area scan camera (12), wherein the device (32) is configured to capture at least one sequence of pixel rows (26) by the area scan camera (12), wherein the pixel rows (26) are aligned with a specified area of a container (10) or a specified area of a container (10) from different rotational positions of the container (10), wherein the device (32) further is configured to assemble the captured sequence of pixel rows (26) to form a row image (28), wherein the pixel rows are captured in temporal and spatial succession.

11. The device (32) according to claim 10, wherein the area scan camera (12) is arranged immovably in the device (32).

12. The device (32) according to claim 10, wherein the device (32) comprises a lens system to avoid image distortions when capturing a sequence of pixel rows (26) by the area scan camera (12).

13. (canceled)

14. The method according to claim 6, wherein the optical lens system includes at least one telecentric, one bi-telecentric and/or one endocentric lens (30).

15. The method according to claim 7, wherein the trigger signal is dependent on a position of the containers (10).

16. The method according to claim 7, wherein the trigger signal is used to synchronize a sequence of pixel rows (26) with a moving container (10) temporally and spatially.

17. The device according to claim 12, wherein the lens system includes at least one telecentric, one bi-telecentric and/or one endocentric lens (30).
